(19) United States
(12) Patent Application Publication
(10) Pub. No.: US 2017/0091013 A1
(43) Pub. Date: Mar. 30, 2017

(54) PCIE ERROR REPORTING AND THROTTLING

(71) Applicant: NetApp, Inc., Sunnyvale, CA (US)

(72) Inventors: Sreenivas Tallam, Sunnyvale, CA (US); David Bachu, Bangalore (IN); Madhu Doddegowda, Bangalore (IN); Gopakumar Thekkedath, Bangalore (IN); Dinakar Medavaram, Bangalore (IN)

(21) Appl. No.: 14/868,262

(22) Filed: Sep. 28, 2015

(51) Int. Cl. G06F 11/07

(52) U.S. Cl. CPC G06F 11/0772; G06F 11/0745; G06F 11/076

(57) ABSTRACT

Examples described herein include an error report throttling mechanism for Peripheral Component Interconnect Express (PCIe) systems. The throwing mechanism updates an interrupt for the first port, and selectively performs an interrupt routine, in response to detecting the error message, based at least in part on the interrupt count for the first port. For example, the throwing mechanism may compare the interrupt count with a reporting threshold to determine whether an error reporting limit has been exceeded for the first port. Upon determining that the error reporting limit has been reached, the throttling mechanism may disable the interrupt routine for subsequent error messages received at the first port.

### TECHNICAL FIELD

Examples described herein relate to Peripheral Component Interconnect Express (PCIe) systems, and more specifically, to a system and method for error reporting in PCIe systems.

### BACKGROUND

Peripheral Component Interconnect Express (PCIe) is a high-performance general purpose input and output (I/O) interconnect. A PCIe “fabric” is a point-to-point bus topology that comprises a root complex having a number of PCIe (“root”) ports coupled to switches, endpoints (e.g., I/O devices), and/or processors (e.g., CPU). Each root port defines a separate hierarchy domain for the root complex. For example, each hierarchy domain may comprise one or more endpoints, switches, and/or sub-hierarchies.

The PCIe specification defines advanced error detection and reporting functions. PCIe errors may be categorized as correctable or uncorrectable. Correctable errors may be resolved in hardware, without software intervention, and without any loss of information. On the other hand, uncorrectable errors cannot be resolved in hardware, and thus impact the functionality of the interface. For example, uncorrectable errors may be caused by hardware (e.g., device and/or link) failures. Such hardware failures often require a reset to return to reliable operation. However, resetting the hardware may result in loss of information.

When an error occurs at a PCIe endpoint, the device may send an error message to the upstream root port of its hierarchy domain. The error message may indicate the source of the error, including a description of the error itself. The error message is then stored in an error register associated with the root port. The root complex sends an interrupt to the CPU to process the error message (e.g., and to analyze the source of the error). In some instances, the root complex may receive a heavy volume of error messages (e.g., from one or more root ports). In response, the root complex may trigger a continuous stream of interrupts to the CPU, thus resulting in degradation of the CPU's performance (e.g., the CPU may be unresponsive to other commands while it is busy handling the heavy volume of errors).

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

In an aspect, an interrupt-throttling mechanism detects an error message at a first port of a root complex of a Peripheral Component Interconnect Express (PCIe) system. For example, the error message may be detected using an interrupt service routine (ISR) that is triggered upon reception of the error message by the first port. Alternatively, the error message may be detected by periodically polling an error register associated with the first port for received error message. The throwing mechanism updates an interrupt for the first port, and selectively performs an interrupt routine, in response to detecting the error message, based at least in part on the interrupt count for the first port.

The interrupt routine may cause the throwing mechanism to generate a first error report based at least in part on the error message, and store the first error report in a circular buffer associated with the root complex. For example, the first error report may indicate that an error was detected in a hierarchy of PCIe devices associated with the first port. The throwing mechanism may further schedule a worker thread to process the first error report. For example, the worker thread may search each PCIe device in the hierarchy to identify one or more error-reporting devices. In an aspect, the worker thread may generate custom error reports based at least in part on information stored in advanced error reporting (AER) registers associated with each of the one or more error-reporting devices.

In some aspects, the throwing mechanism may compare the interrupt count with a reporting threshold to determine whether an error reporting limit has been exceeded for the first port. Upon determining that the error reporting limit has been reached, the throwing mechanism may disable the interrupt routine for subsequent error messages received at the first port. In some aspects, the interrupt routine may be re-enabled after the worker thread has finished searching each PCIe device in the hierarchy. For example, re-enabling the interrupt routine may include resetting the interrupt count for the first port.

In another aspect, the throwing mechanism may determine that the error message identifies a correctable error. The throwing mechanism may further determine whether a correctable error reporting limit has been reached for the first port. If the correctable error reporting limit has been reached, the throwing mechanism may bypass the interrupt routine for the error message.

By limiting the reporting of errors at a root port to a threshold amount, the interrupt-throttling mechanism allows a high volume of errors at the root port to be resolved in a timely manner, without overloading the bandwidth of a CPU. Moreover, the interrupt-throwing mechanism enables the reporting of uncorrectable errors (e.g., which may have dire consequences) to be prioritized over the reporting of correctable errors.

### BRIEF DESCRIPTION OF THE DRAWINGS

FIGS. 1A and 1B show a PCIe system with interrupt throwing functionality, in accordance with some aspects.

FIG. 2 shows a root complex with interrupt throttling functionality, in accordance with some aspects.

FIG. 3 is a flowchart illustrating an operation for throttling interrupts based on errors detected in a PCIe system, in accordance with some aspects.

FIG. 4 is a flowchart illustrating a more detailed operation for throttling interrupts based on errors detected in a PCIe system, in accordance with some aspects.

FIG. 5 is a flowchart illustrating an operation for processing errors in a PCIe system with interrupt throwing, in accordance with some aspects.

FIG. 6 is a block diagram that illustrates a computer system upon which aspects described herein may be implemented.

### DETAILED DESCRIPTION

Examples described herein include a Peripheral Component Interconnect Express (PCIe) system with interrupt throttling functionality. As used herein, the term “throwing” means limiting or restricting by a threshold amount. Furthermore, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more aspects described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more aspects described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more aspects can be executed and/or carried. For example, a machine shown in one or more aspects includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

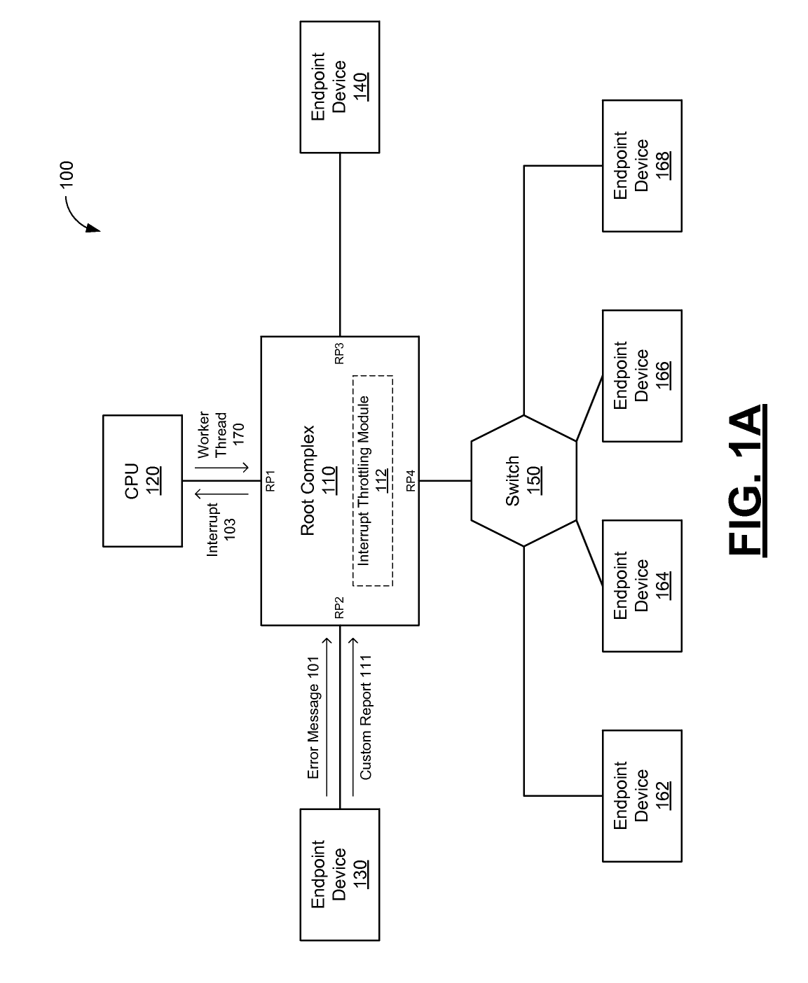

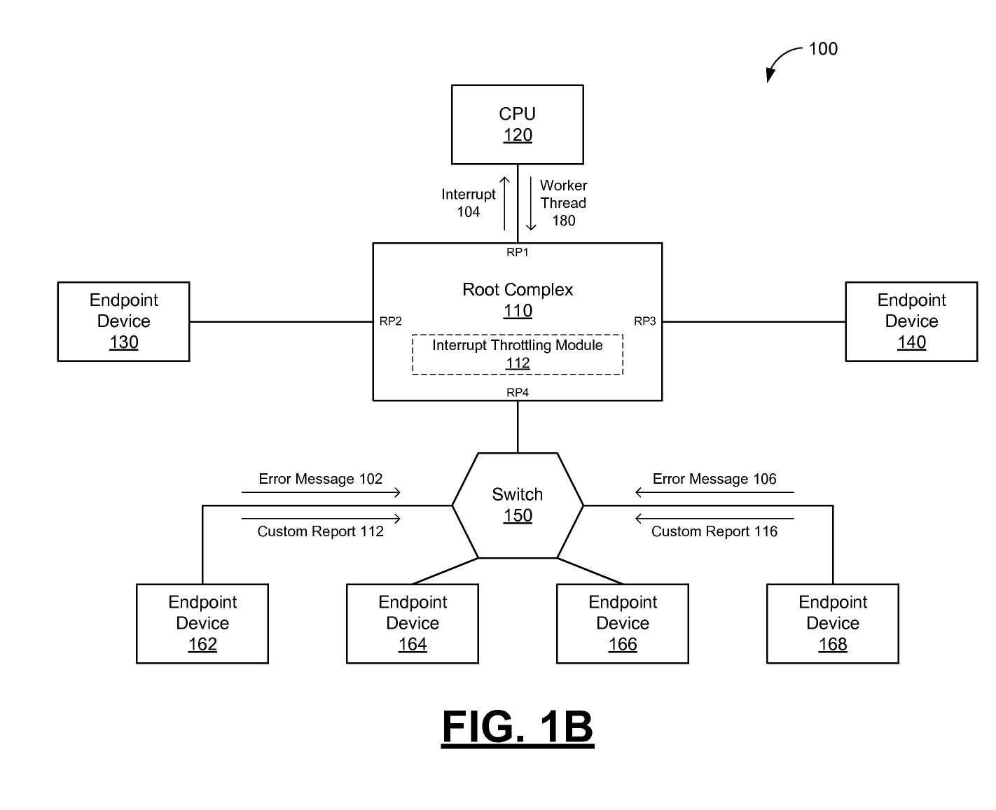

FIGS. 1A and 1B show a PCIe system 100 with interrupt throttling functionality, in accordance with some aspects. The PCIe system 100 includes a root complex 110, a central processing unit (CPU) 120, a first endpoint device 130, a second endpoint device 140, and a switch 150. The CPU 120 is coupled to a first root port RP1 of the root complex 110. The first endpoint device 130 is coupled to a second root port RP2 of the root complex 110. The second endpoint device 140 is coupled to a third root port RP3 of the root complex 110. The switch 150 is coupled to a fourth root port RP4 of the root complex 110. The switch 150 is further coupled to a number of additional endpoint devices 162-168. The root complex 110 is shown to include four root ports RP1-RP4 for simplicity only. In other aspects, the root complex 110 may include fewer or more root ports than those shown.

The root complex 110 provides a logical point-to-point connection (e.g., “interconnect” or “link”) between devices coupled to its respective root ports RP1-RP4. For example, a PCIe link between root ports RP1 and RP2 may enable the CPU 120 to communicate with endpoint device 130 (e.g., as a “requester” or “completer” of a PCIe transaction). Furthermore, a PCIe link between root ports RP1 and RP4 may allow the CPU 120 to communicate with any of endpoint devices 162-168 (e.g., via the switch 150). The root ports RP1-RP4 define respective hierarchy domains for the root complex 110. For example, the hierarchy domains associated with root ports RP1, RP2, and RP3 each comprise only one PCIe device (e.g., CPU 120, endpoint device 130, and endpoint device 140, respectively). However, the hierarchy domain associated with the fourth root port RP4 includes at least five PCIe devices (e.g., switch 150 and endpoint devices 162-168).

The root complex 110 may also record and report errors detected in the connections and/or devices of the PCIe system 100. For example, with reference to FIG. 1A, when an error is detected in endpoint device 130, the endpoint device 130 may send an error message 101 to the root port in its hierarchy (e.g., RP2). The error message 101 may include a requester ID and a description of the error. For example, the requester ID may include information identifying endpoint device 130 as the originator of the error message 101. The error description may specify whether the error is correctable, uncorrectable, and/or other information indicating the type of error that occurred. The error message 101 may be stored in an error register (not shown for simplicity) associated with the second root port RP2.

Upon detecting the error message 101, the root complex 110 may report the error to the CPU 120 by signaling an interrupt 103. In some aspects, the root complex 110 may automatically generate the interrupt 103 upon receiving the error message 101. For example, an interrupt service routine (ISR) may be invoked in the root complex 110 upon receiving the error message 101 from the endpoint device 130. The ISR causes the root complex 110 to read the error register associated with the root port RP2 and signal the interrupt 103 to the CPU 120. In other aspects, the root complex 110 may generate the interrupt 103 after detecting the error message 101 stored in the error register. For example, the root complex 110 may periodically poll the error registers associated with each of its root ports RP1-RP4 for stored error messages. The root complex 110 may then signal the interrupt 103 to the CPU 120 upon detecting the error message 101 stored in the error register associated with root port RP2.

The interrupt signal 103 causes the CPU 120 to suspend its current processes and handle the reported error. For example, the CPU 120 may schedule a worker thread 170 for the error-detecting port (e.g., RP2) of the root complex 110, in response to the interrupt 103. The worker thread 170 may then attempt to retrieve more detailed error information from the actual error-reporting device (e.g., endpoint device 130) coupled to the root port RP2. For example, the worker thread 170 may generate a custom error report 111 based on information stored in an advanced error reporting (AER) register of the endpoint device 130. The custom error report 111 may be sent back to the root complex 110 for further analysis and/or error recovery purposes. When the worker thread 170 has finished servicing the endpoint device 130, it may clear the error message 101 from the error register associated with the root port RP2.

In some instances, the endpoint device 130 may repeatedly send error messages to the root port RP2. For example, multiple errors may occur in the endpoint device 130 within a short duration. Alternatively, and/or in addition, the endpoint device 130 may repeatedly report the same error to the root port RP2 (e.g., due to faulty hardware and/or software in the endpoint device 130). However, it may be undesirable to report all of the errors to the CPU 120 (e.g., from the same root port), because a high volume of interrupts 103 may significantly degrade the performance of the CPU 120.

For some aspects, the root complex 110 may include an interrupt throwing module 112 to throttle or limit the number of interrupts 103 signaled to the CPU 120. For example, the interrupt throttling module 112 may maintain a count (e.g., an “interrupt count”) of the number of error messages received at the root port RP2. Once the interrupt count reaches a threshold amount (e.g., a “reporting threshold”), the interrupt throwing module 112 may disable interrupt signaling for the corresponding root port RP2. For example, if the reporting threshold for the root port RP2 is set to “1,” the interrupt throttling module 112 may prevent the signaling of interrupts 103 to the CPU 120 for any additional errors messages received by the root port RP2 beyond the first error message 101. The worker thread 170 may subsequently re-enable interrupt signaling for the root port RP2 after it has read the AER register of the endpoint device 130 and cleared the error message 101 from the error register associated with the root port RP2.

In some instances, multiple endpoint devices may report errors to the same root port. For example, with reference to FIG. 1B, endpoint device 162 may send an error message 102 to the root port RP3 (e.g., via the switch 150). Immediately thereafter, endpoint device 168 may also send an error message 106 to the root port RP3 (e.g., via the switch 150). However, if the reporting threshold for the root port RP3 is set to “1,” the error message 102 reported by endpoint device 162 will trigger an interrupt signal 104 to the CPU 120, whereas the error message 106 reported by endpoint device 168 will be throttled by the interrupt throttling module 112. In an aspect, the error message 106 may still be stored in an error register associated with the root port RP3.

In some aspects, the root complex 110 may enable a search of an entire hierarchy domain each time it signals an interrupt 104 to the CPU 120. For example, upon detecting the error message 102, the root complex 110 may report the error to the CPU 120 by signaling the interrupt 104. The CPU 120 responds to the interrupt 104 by sending a worker thread 180 to the error-detecting port (e.g., RP3) of the root complex 110. The worker thread 180 may then search each of the PCIe devices (e.g., endpoint devices 162-168 and/or switch 150) in the hierarchy domain associated with the root port RP3, to identify one or more error-reporting devices.

For example, the worker thread 180 may begin by searching first endpoint device in the hierarchy (e.g., endpoint device 162) for errors. Upon detecting an error at the endpoint device 162, the worker thread 180 may send a CE report 112 back to the root complex 110 based on information stored in the AER register associated with endpoint device 162. The worker thread 180 may then move on to search respective endpoint devices 164 and 166 for errors. However, since no errors are detected in either of the endpoint devices 164 and/or 166, the worker thread 180 may simply proceed to search endpoint device 168 for errors. Upon detecting an error at the endpoint device 168, the worker thread 180 may send another CE report 116 back to the root complex 110 based on information stored in the AER associated with endpoint device 168.

The above process ensures that the worker thread 180 will be able to service any error-reporting devices that attempted to report an error after interrupt signaling has been disabled for a corresponding root port. Accordingly, the present aspects allow for multiple errors and/or error-reporting devices to be serviced in response to a single CPU interrupt. Once the worker thread 180 has finished servicing each of the endpoint devices 162-168 in the hierarchy domain associated with the root port RP3, it may clear any error messages (e.g., error messages 101 and 102) stored in the error register associated with root port RP3.

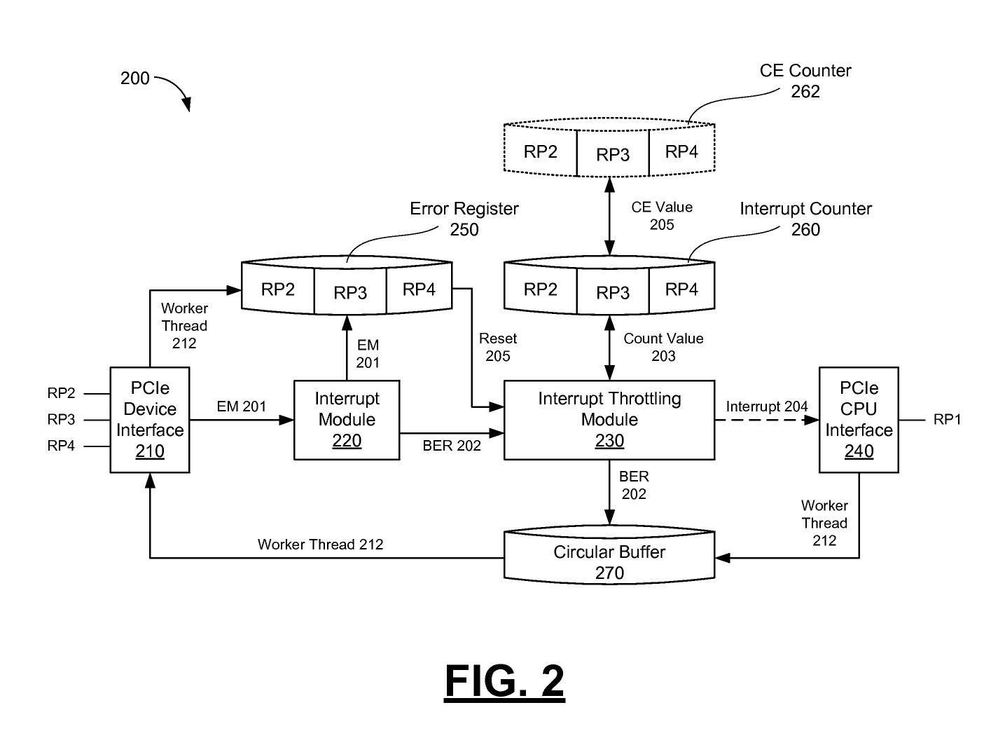

FIG. 2 shows a root complex 200 with interrupt throttling functionality, in accordance with some aspects. The root complex 200 of FIG. 2 may be an aspect of the root complex 110 described above with respect to FIG. 1. The root complex 200 include a PCIe device interface 210, an interrupt module 220, an interrupt throwing module 230, a PCIe CPU interface 240, an error register 250, an interrupt counter 260, a correctable error (CE) counter 262, and a circular buffer 270. The CPU interface includes a first root port RP1 which may be coupled to a processor or CPU (e.g., CPU 120). The device interface 210 includes a number of additional root ports RP2-RP4 which may be coupled to respective PCIe devices (e.g., such as endpoint devices 130 and 140, and/or switch 150).

The interrupt module 220 may receive error messages (EM) 201 via one or more of the root ports RP2-RP4 of the device interface 210. As described above, the error message 201 may include a requester ID and a description of the error. Upon receiving an error message 201, the interrupt module 220 may store the error message 201 in a corresponding partition of the error register 250 associated with the root port at which the error message 201 was received. For example, if the error message 201 is received via root port RP2, the interrupt module 220 may store the error message 201 in the “RP2” partition of the error register 250.

The interrupt module 220 further generates a basic error report (BER) 202 based on the received error message 201. The basic error report may contain minimal information about the reported error. In some aspects, the BER 202 may simply identify the root port that received the error message 201. In other aspects, the BER 202 may also indicate the type of error (e.g., correctable or uncorrectable) identified by the error message 201. For example, the BER 202 may indicate that a correctable error was detected at root port RP2.

The interrupt throwing module 230 receives the BER 202 and updates an interrupt count value 203 stored in the interrupt counter 260. More specifically, the interrupt throwing module 230 may update the count value 203 associated with the root port identified by the BER 202. For example, upon receiving the BER 202 identifying root port RP2, the interrupt throwing module 230 may increment the count value 203 stored in the “RP2” partition of the interrupt counter 260. In some aspects, the interrupt throwing module 230 may also update a CE value 205 stored in the CE counter 262. For example, if the BER 202 indicates that a correctable error was detected at the root port RP2, the interrupt throttling module 230 may increment the CE value 205 stored in the “RP2” partition of the CE counter 262.

The interrupt throwing module 230 further compares the count value 203 for the corresponding root port with a reporting threshold to determine whether an error reporting limit has been reached for that root port. If the reporting threshold has not been exceed (e.g., or reached), the interrupt throwing module 230 may store the BER 202 in the circular buffer 270 and signal an interrupt 204 to a CPU (e.g., CPU 120) via the CPU interface 240. Otherwise, if the reporting threshold has been exceeded, the interrupt throwing module 230 may disable interrupt signaling for the corresponding root port (e.g., by masking the error register 250 for RP2).

For example, if the error reporting threshold for the root port RP2 is set to “1,” a maximum of one CPU interrupt may be triggered by the root port RP2 (e.g., until the corresponding count value 203 is reset). Thus, if the updated count value 203 associated with root port RP2 is also “1,” the interrupt throttling module 230 may store the BER 202 in the circular buffer 270 and signal the interrupt 204 to the CPU. At this point, any subsequent BERs originating from the root port RP2 will be throttled or filtered by the interrupt throwing module 230.

In response to the interrupt signal 204, the CPU interface 240 may receive a worker thread 212 from the CPU (e.g., via the root port RP1). The worker thread 212 reads the BER 202 stored in the circular buffer to determine that an error was detected at the root port RP2. The worker thread 212 may then search each PCIe device in the hierarchy domain associated with root port RP2 to identify one or more error-reporting devices. In some aspects, the worker thread 212 may send custom error reports (not shown for simplicity) back to the root complex 200 for further analysis and/or error recovery. After servicing each device in the hierarchy domain associated with root port RP2, the worker thread 212 may clear any stored error messages associated with the root port RP2. For example, the worker thread 212 may clear any error messages stored in the “RP2” partition of the error register 250.

Upon clearing all error messages for a particular root port, the worker thread 212 may generate a reset signal 205. The reset signal 205 may identify the particular root port partition of the error register 250 that was recently cleared. The interrupt throttling module 230 receives the reset signal 205 and re-enables interrupt signaling for the corresponding root port (e.g., by unmasking the error register 250 for RP2). For example, upon receiving the reset signal 205 indicating that the error messages for root port RP2 have been cleared, the interrupt throwing module 230 may reset the count value 203 stored in the “RP2” partition of the interrupt counter 260.

In some aspects, the interrupt throwing module 230 may selectively throttle interrupts based on the type of error being reported. As described above, uncorrectable errors result in data loss, whereas correctable errors do not. Thus, it may be desirable to prioritize the handling of uncorrectable errors over correctable errors, for example, by limiting the number of interrupts generated for correctable errors.

For example, upon receiving the BER 202, the interrupt throttling module 230 may compare the CE value 205 for the corresponding root port with a CE threshold to determine whether a correctable error reporting limit has been reached. If the CE threshold has been exceeded, the interrupt throwing module 230 may prevent the signaling of an interrupt 204 for the received error message 201 (e.g., even if the error reporting limit has not been reached).

In some aspects, interrupt throwing may be performed for each of the root ports RP2-RP4 separately (e.g., on an individual basis). For example, disabling interrupts for root port RP2 may not affect the interrupt signaling configuration for root port RP3. Thus, while error messages received at root port RP2 may be prevented from triggering CPU interrupts, error messages received at any of the other root ports RP3 and/or RP4 may still trigger CPU interrupts (e.g., as long as the reporting limit has not been reached for the respective root ports).

For example, if a new error message 201 is received via root port RP3, the interrupt module 220 may generate a new BER 202 identifying root port RP3 as an error-detecting port. In some aspects, the BER 202 may also indicate whether a correctable (or uncorrectable) error is identified by the error message 201. The interrupt throwing module 230 receives the new BER 202 and updates a count value 203 stored in the “RP3” partition of the interrupt counter 260. If the BER 202 indicates that a correctable error was detected at the root port RP3, the interrupt throttling module 230 may further increment the CE value 205 stored in the “RP3” partition of the CE counter 262.

The interrupt throwing module 230 compares the count value 203 for root port RP3 with a reporting threshold to determine whether an error reporting limit has been reached and/or exceed for the root port RP3. In some aspects, the reporting threshold for root port RP3 may be the same as the reporting threshold for root port RP2. In other aspects, the reporting threshold for root port RP3 may be different (e.g., greater or lower) than the reporting threshold for root port RP2. If the error reporting threshold has not been exceed, the interrupt throwing module 230 may add the new BER 202 (e.g., for root port RP3) to the circular buffer 270 and signal an interrupt 204 to the CPU.

For some aspects, the circular buffer 270 may be a first-in first-out (FIFO) memory. Thus, the new BER 202 may be added to the back of the queue (e.g., behind the BER 202 stored for root port RP2). Once the worker thread 212 has finished processing the BER 202 for root port RP2 (e.g., after clearing the error messages stored in the “RP2” partition of the error register 250), the worker thread 212 may then proceed to the next BER 202 stored in the circular buffer 270 (e.g., and search the hierarchy domain associated with root port RP3 for errors). The worker thread 212 may terminate after processing (e.g., and clearing) all of the BERs stored in the circular buffer 270.

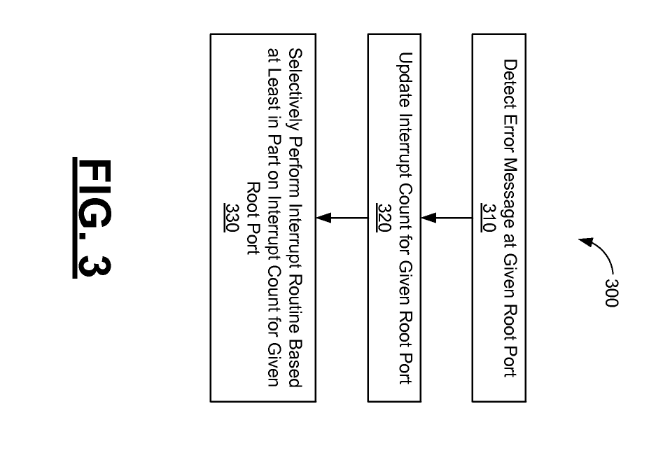

FIG. 3 is a flowchart illustrating an operation 300 for throttling interrupts based on errors detected in a PCIe system, in accordance with some aspects. Examples such as described with FIG. 3 can be implemented using, for example, a system such as described with FIGS. 1A-1B and 2. Accordingly, reference may be made to elements of FIGS. 1A-1B and 2 for purposes of illustrating suitable elements and/or components for performing a step or sub-step being described. More specifically, the operation 300 may be implemented, for example, by the root complex 110 as described above with respect to FIGS. 1A-1B.

The root complex 110 detects an error message at a given root port (310). For example, when an error is detected in one of the endpoint devices 130, 162, 164, 166, and/or 168, that endpoint device may send an error message to the root port in its respective hierarchy domain. The error message may include a requester ID and a description of the error. As described above, the requester ID may include information identifying the endpoint device that sent the message (e.g., the error-reporting device). The error description may specify whether the error is of a correctable or uncorrectable error type. The error message may be stored in an error register (not shown for simplicity) associated with the corresponding root port.

The root complex 110 then updates an interrupt count for the given root port (320). In some aspects, the interrupt count may reflect the total number of interrupts signaled to the CPU 120 for each of the root ports RP1-RP4 of the root complex 110. For example, the interrupt throttling module 112 may update (e.g., increment) the count value for a particular root port each time the root complex 110 signals an interrupt to the CPU 120 in response to an error message received at the particular root port. In other aspects, the interrupt count may reflect the total number of error messages received at each of the root ports RP1-RP4 of the root complex 110. For example, the interrupt throwing module 112 may update (e.g., increment) the count value for a particular root port each time an error message is received at that root port (e.g., regardless of whether an interrupt was signaled to the CPU 120).

The root complex 110 selectively performs an interrupt routine based at least in part on the interrupt count for the given root port (330). For example, the interrupt throttling module 112 may compare the interrupt count for the given root port with a reporting threshold for that root port to determine whether an error reporting limit has been reached. If the interrupt count exceeds (or has reached) the reporting threshold, the interrupt throwing module 112 may disable interrupt signaling for the corresponding root port. Specifically, if the error reporting limit has been reached for a given root port, the interrupt throwing module 112 may prevent the signaling of interrupts in response to any additional error messages received at that root port. In some aspects, the interrupt count may be reset after a worker thread has identified all error-reporting devices in the hierarchy domain for the corresponding root port (e.g., and cleared the error register associated with the root port).

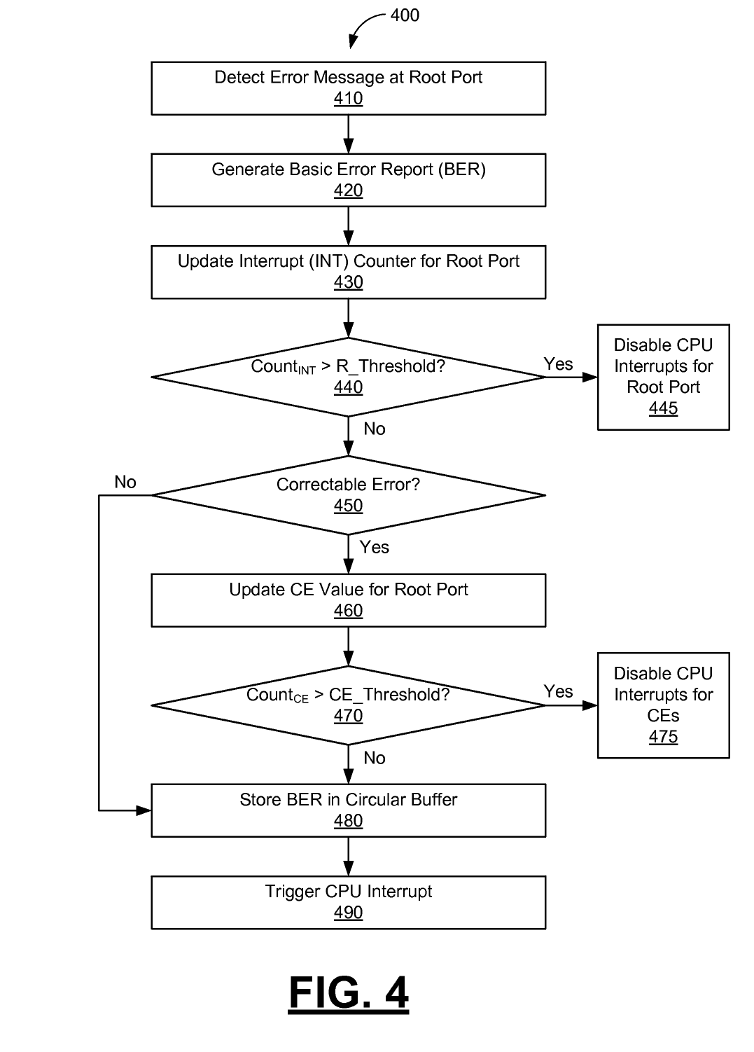

FIG. 4 is a flowchart illustrating a more detailed operation 400 for throttling interrupts based on errors detected in a PCIe system, in accordance with some aspects. Examples such as described with FIG. 4 can be implemented using, for example, a system such as described with FIGS. 1A-1B and 2. Accordingly, reference may be made to elements of FIGS. 1A-1B and 2 for purposes of illustrating suitable elements and/or components for performing a step or sub-step being described. More specifically, the operation 400 may be implemented, for example, by the root complex 200 as described above with respect to FIG. 2.

The root complex 200 detects an error message at one of its root ports (410). For example, the interrupt module 220 may receive an error message 201 (e.g., from an endpoint device) via one of the root ports RP2-RP4 of the PCIe device interface 210. As described above, the error message 201 may include a requester ID (e.g., identifying the error-reporting device) and/or a description of the error (e.g., whether the error is a correctable or uncorrectable error type). In some aspects, the interrupt module 220 may store the error message 201 in a corresponding partition (e.g., “RP2,” “RP3,” or “RP4”) of the error register 250 associated with the root port at which the error message 201 was received.

The root complex 200 generates a basic error report (BER) for the error-detecting root port (420). For example, the interrupt module 220 may generate the BER 202 based on the received error message 201. In some aspects, the BER 202 may contain minimal information about the reported error. For example, the BER 202 may identify the root port (e.g., root port RP2, RP3, or RP4) that received the error message 201 and/or the type of error (e.g., correctable or uncorrectable) indicated by the error message 201.

The root complex 200 updates an interrupt counter associated with the error-detecting root port (430). For example, the interrupt throttling module 230 may receive the BER 202 from the interrupt module 220. Upon receiving the BER 202, the interrupt throwing module 230 may update (e.g., increment) the interrupt count value 203 stored in a partition of the interrupt counter 260 associated with the root port identified by the BER 202.

The interrupt counter (Count_{INT}) is compared with a reporting threshold (R_Threshold) to determine whether an error reporting limit has been reached and/or exceed for the corresponding root port (440). If the count value 203 exceeds the reporting threshold (as tested at 440), the root complex 200 may disable interrupt signaling for the corresponding root port (445). For example, while interrupt signaling is disabled for a given root port, the interrupt throwing module 230 may throttle or ignore any BERs received for that root port (e.g., by preventing the signaling of interrupts 204 in response to the received BERs).

If the count value 203 does not exceed the reporting threshold (as tested at 440), the root complex 200 then determines whether the received BER 202 indicates a correctable error (450). If the BER 202 indicates that a correctable error was detected at the corresponding root port (as tested at 450), the root complex 200 may update a correctable error counter associated with that root port (460). For example, the interrupt throwing module 230 may update (e.g., increment) the CE value 205 stored in a partition of the CE counter 262 associated with the root port identified by the BER 202.

The root complex 200 may further compare the correctable error counter (Count_{CE}) for the corresponding root port with a correctable error threshold (CE_Threshold) to determine whether a correctable error reporting limit has been reached (470). If the CE value 205 exceeds the correctable error threshold (as tested at 470), the root complex 200 may prevent or disable interrupt signaling for correctable errors associated with the corresponding root port (475). For example, the interrupt throwing module 230 may throttle or ignore any BERs 202 identifying correctable errors associated with the given root port.

If the CE value 205 does not exceed the correctable error threshold (as tested at 470), or if the received BER 202 indicates an uncorrectable error (as tested at 450), the root complex 200 may store the BER 202 in a circular buffer (480) and signal an interrupt to a CPU (490). For example, the interrupt throwing module 230 may add the BER 202 to the back of a BER queue stored in the circular buffer 270. The interrupt throwing module 230 may further signal an interrupt 204 to the CPU. In response to the interrupt 204, the CPU may send a worker thread 212 to the root complex 200 to process (and clear) each BER 202 stored in the circular buffer 270.

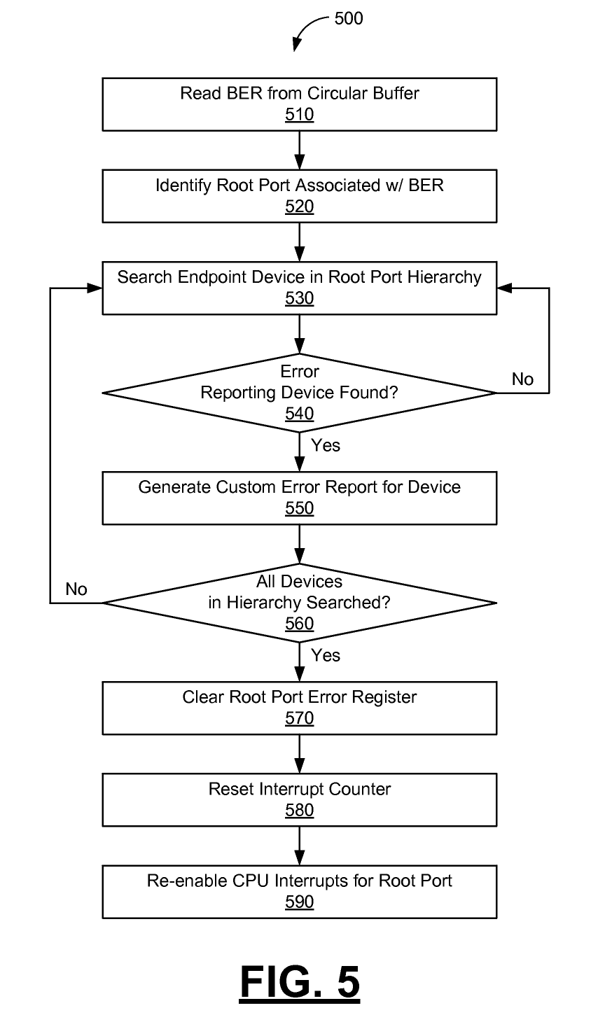

FIG. 5 is a flowchart illustrating an operation 500 for processing errors in a PCIe system with interrupt throwing, in accordance with some aspects. Examples such as described with FIG. 4 can be implemented using, for example, a system such as described with FIGS. 1A-1B and 2. Accordingly, reference may be made to elements of FIGS. 1A-1B and 2 for purposes of illustrating suitable elements and/or components for performing a step or sub-step being described. More specifically, the operation 400 may be implemented, for example, by the root complex 200 as described above with respect to FIG. 2.

As described above, a CPU may send a worker thread 212 to the root complex 200 in response to receiving an interrupt 204 from the root complex 200. The worker thread 212 first reads a BER 202 from the circular buffer 270 (510) and identifies a root port associated with the BER 202 (520). As described above the circular buffer 270 may be a FIFO memory. Thus, the worker thread 212 may read the first BER 202 stored in the circular buffer 270. In some aspects, the BER 202 may contain minimal information about the reported error. For example, the BER 202 may simply indicate the root port (e.g., root port RP2, RP3, or RP4) that received a corresponding error message 201 and/or a type of error detected (e.g., correctable or uncorrectable).

The worker thread 212 may then search a first endpoint device in the hierarchy domain associated with the identified root port (530) to determine whether the endpoint device is an error-reporting device (540). As described above, with respect to FIGS. 1A and 1B, each of the root ports RP2-RP4 may be coupled to one or more endpoint devices. In some aspects, the worker thread 212 may select any endpoint device coupled to the root port identified by the BER 202 to begin the error searching process. For example, the worker thread 212 may read an AER register of the selected endpoint device to look for errors. If no errors are detected in the selected endpoint device (as tested at 540), the worker thread 212 selects a different (e.g., the next) endpoint device in the hierarchy domain to search (530).

If the worker thread 212 detects an error in the selected endpoint device (as tested at 540), the worker thread 212 may generate a custom error report for the selected device (550). For example, the worker thread 212 may generate the custom error report based on information stored in the AER register associated with the selected device. The custom error report may be sent back to the root complex 200 for further analysis and/or error recovery purposes.

When the worker thread has finished servicing the selected endpoint device, it may determine whether there are any remaining endpoint devices in the current hierarchy domain that have not yet been searched (560). As long as there are still potential error-reporting devices in the current hierarchy domain (as tested at 560), the worker thread 212 may select a new endpoint device in the hierarchy domain to continue searching for errors (530). After the worker thread 212 has completed searching all endpoint devices in the associated hierarchy domain (as tested at 560), the worker thread 212 may clear a root port error register associated with the given root port (570). For example, the worker thread 212 may clear any error messages 201 stored in a corresponding partition (e.g., “RP2,” “RP3”, or “RP4”) of the error register 250.

The worker thread 212 may then reset an interrupt counter for the given root port (580) and re-enable CPU interrupts for the root port (590). For example, the worker thread 212 may generate a reset signal 205 upon clearing all error messages for the given root port. The reset signal 205 may identify the particular root port partition of the error register 250 that was recently cleared. The interrupt throttling module 230 may receive the reset signal 205 and reset the interrupt count value 203 stored in the corresponding partition of the interrupt counter 260 for the root port identified by the reset signal 205. In some aspects, the interrupt throttling module 230 may also reset the CE value 205 stored in the corresponding partition of the CE counter 262 for the root port identified by the reset signal 205. Finally, upon resetting the count value 203 (and the CE value 205), the interrupt throwing module 230 may re-enable interrupt signaling for the root port identified by the reset signal 205.

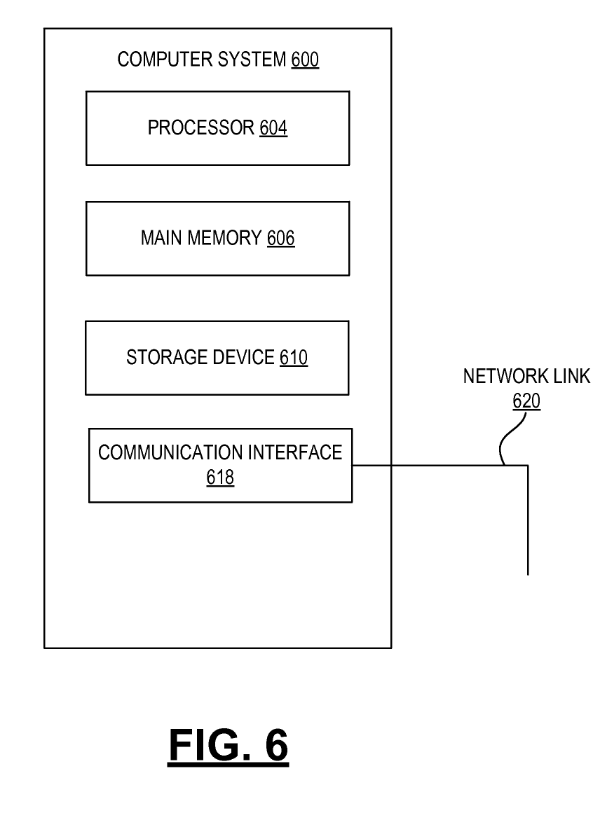

FIG. 6 is a block diagram that illustrates a computer system upon which aspects described herein may be implemented. For example, in the context of FIG. 2, the root complex 200 may be implemented using one or more computer systems such as described by FIG. 6. In addition, methods such as described with FIGS. 3-5 can be implemented using a computer such as described with an example of FIG. 6.

In some aspects, computer system 600 includes processor 604, memory 606 (including non-transitory memory), storage device 610, and communication interface 618. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. A storage device 610, such as a magnetic disk or optical disk, is provided for storing information and instructions. The communication interface 618 may enable the computer system 600 to communicate with one or more networks through use of the network link 620 (wireless or wireline).

In one implementation, memory 606 may store instructions for implementing functionality such as described with an example of FIGS. 1A-1B and 2, or implemented through an example method such as described with FIGS. 3-5. Likewise, the processor 604 may execute the instructions in providing functionality as described with FIGS. 1A-1B and 2, or performing operations as described with an example method of FIGS. 3-5.

Examples described herein are related to the use of computer system 600 for implementing the techniques described herein. According to one aspect, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative examples have been described in detail herein with reference to the accompanying drawings, variations to specific aspects and details are encompassed by this disclosure. It is intended that the scope of aspects described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A method of error reporting in a Peripheral Component Interconnect Express (PCIe) system, the method comprising:
detecting an error message at a first port of a root complex of the PCIe system;
updating an interrupt count for the first port; and
selectively performing an interrupt routine, in response to detecting the error message, based at least in part on the interrupt count for the first port.

2. The method of claim 1, wherein selectively performing the interrupt routine comprises:
comparing the interrupt count with a reporting threshold to determine whether an error reporting limit has been exceeded for the first port; and
upon determining that the error reporting limit has been reached, disabling the interrupt routine for subsequent error messages received at the first port.

3. The method of claim 1, wherein the interrupt routine comprises:
generating a first error report based at least in part on the error message;
storing the first error report in a circular buffer associated with the root complex; and
scheduling a worker thread to process the first error report.

4. The method of claim 3, wherein the first error report indicates that an error was detected in a hierarchy of PCIe devices associated with the first port, and wherein the worker thread processes the first error report by searching each PCIe device in the hierarchy to identify one or more error-reporting devices.

5. The method of claim 4, wherein the worker thread generates custom error reports based at least in part on information stored in advanced error reporting (AER) registers associated with each of the one or more error-reporting devices.

6. The method of claim 4, further comprising:
re-enabling the interrupt routine after the worker thread has finished searching each PCIe device in the hierarchy.

7. The method of claim 6, wherein re-enabling the interrupt routing comprises:
resetting the interrupt count for the first port.

8. The method of claim 1, further comprising:
determining that the error message identifies a correctable error;
determining whether a correctable error reporting limit has been reached for the first port; and
bypassing the interrupt routine for the error message if the correctable error reporting limit has been reached.

9. The method of claim 1, wherein the error message is detected using an interrupt service routine (ISR) that is triggered upon reception of the error message by the first port.

10. The method of claim 1, wherein the error message is detected by periodically polling an error register associated with the first port for received error messages

11. A Peripheral Component Interconnect Express (PCIe) system comprising:
a memory containing machine readable medium comprising machine executable code having stored thereon;
a processing module, coupled to the memory, to execute the machine executable code to:
detect an error message at a first port of a root complex of the PCIe system;
update an interrupt count for the first port; and
selectively perform an interrupt routine, in response to detecting the error message, based at least in part on the interrupt count for the first port.

12. The PCIe system of claim 11, wherein execution of the machine executable code for selectively performing the interrupt routine causes the processor to:
compare the interrupt count with a reporting threshold to determine whether an error reporting limit has been exceeded for the first port; and
upon determining that the error reporting limit has been reached, disable the interrupt routine for subsequent error messages received at the first port.

13. The PCIe system of claim 11, wherein the interrupt routine comprises:
generating a first error report based at least in part on the error message;
storing the first error report in a circular buffer associated with the root complex; and
scheduling a worker thread to process the first error report.

14. The PCIe system of claim 13, wherein the first error report indicates that an error was detected in a hierarchy of PCIe devices associated with the first port, and wherein the worker thread processes the first error report by searching each PCIe device in the hierarchy to identify one or more error-reporting devices.

15. The PCIe system of claim 14, wherein the worker thread generates custom error reports based at least in part on information stored in advanced error reporting (AER) registers associated with each of the one or more error-reporting devices.

16. The PCIe system of claim 14, wherein execution of the machine executable code further causes the processor to:
re-enable the interrupt routine after the worker thread has finished searching each PCIe device in the hierarchy.

17. The PCIe system of claim 11, wherein execution of the machine executable code further causes the processor to:
determine that the error message identifies a correctable error;
determine whether a correctable error reporting limit has been reached for the first port; and
bypass the interrupt routine for the error message if the correctable error reporting limit has been reached.

18. The PCIe system of claim 11, wherein execution of the machine executable code for detecting the error message causes the processor to:
trigger an interrupt service routine (ISR) upon reception of the error message by the first port.

19. The PCIe system of claim 11, wherein execution of the machine executable code for detecting the error message causes the processor to:
periodically poll an error register associated with the first port for received error messages.

20. A computer-readable medium for reporting errors in a Peripheral Component Interconnect Express (PCIe) fabric, the computer-readable medium storing instructions that, when executed by one or more processors, cause the one or more processors to perform operations comprising:
detecting an error message at a first port of a root complex of the PCIe fabric;
updating an interrupt count for the first port; and
selectively performing an interrupt routine, in response to detecting the error message, based at least in part on a number of interrupt routines previously triggered by the first port.
